(19) United States
(12) Patent Application Publication
(10) Pub. No.: US 2007/0239847 A1
(43) Pub. Date: Oct. 11, 2007

(54) Recording apparatus, reproducing apparatus, recording and reproducing apparatus, recording method, reproducing method, recording and reproducing method and recording medium

(75) Inventors: Mitsuru Takehara, Tokyo (JP); Yoichiro Sako, Tokyo (JP); Toshiro Terauchi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/729,460

(22) Filed: Mar. 29, 2007

(30) Foreign Application Priority Data
Apr. 5, 2006 (JP) JP2006-104264

(51) Int. Cl. G06F 15/16

(52) U.S. Cl. 709/217

(57) ABSTRACT

A recording and reproducing apparatus and method and a recording medium are disclosed. Operation metadata is generated using operating information from an operation input unit for controlling the operation of a content provider. A recording processing unit records the generated operation metadata in a recording medium in association with the contents. A reproduction processing unit reproduces the operation metadata from the recording medium. A reproduction control unit reproduces the contents in a reproduction mode corresponding to the operation metadata. An operation metadata generating unit generates operation metadata using operating information for a single or plurality of contents. Further, a biological information measuring unit measures biological information of a user and an environment measuring unit measures the surrounding environment of the user at the time of content reproduction. A sensing metadata generating unit generates sensing metadata using information detected by the biological information measuring unit and/or the environment measuring unit.

### CROSS REFERENCES TO RELATED APPLICATIONS

The present invention contains subject matter related to Japanese Patent Application JP2006-104264 filed in the Japanese Patent Office on Apr. 5, 2006, the entire contents of which being incorporated herein by reference.

### BACKGROUND OF THE INVENTION

1. Field of the Invention

The present invention relates to a recording apparatus and a recording method for generating operation metadata using operating information from a remote control unit, for example, and recording the generated operation metadata in a recording medium, and also relates to a reproducing apparatus, a recording and reproducing apparatus, a reproducing method and a recording and reproducing method for reproducing contents in accordance with the operation metadata recorded in the recording medium. The invention further relates to a recording medium having the operation metadata recorded therein.

2. Description of the Related Art

Additional data called metadata are often recorded in association with a recording medium having contents of a movie, a music or a photo, etc. recorded therein. In the case where the contents are a movie, the cast, the director, the year of production and the summary, etc. of the movie are recorded as metadata in the recording medium. In the case where the music contents are involved, on the other hand, the title, the genre, the performance time and the performer, etc. are recorded as metadata. These metadata may be reproduced independently of the contents. A viewer of the contents, therefore, can easily know one aspect of the contents by way of the metadata.

In the case where a plurality of music contents are recorded in an optical disk, a user is not necessarily fond of all the music contents recorded. Usually, the user selects and reproduces his/her favorite music content preferentially. With regard to a given music content, on the other hand, the reproduction point may be adjusted to a favorite phrase, if any, and repeatedly reproduced. In such a case, the user reproduces the favorite music or adjusts the reproduction point of the music contents using an operation input unit such as a remote control unit.

In the case where a movie or a recorded program is recorded in an optical disk, on the other hand, a user may reproduce the movie or the program by adjusting the reproduction point to a scene which has moved him/her. In such a case, the user adjusts the reproduction point using an operation input unit of a remote control unit.

These contents of a movie or a music are generally narrative, and in accordance with the development of a story or a scene, the psychological state of the user undergoes a change. Specifically, in accordance with the scene of the contents, the user is surprised, moved, relieved, excited or otherwise harbors different emotions. This change of the user emotion is expressed as a change in the expression, perspiration, heart rate, blood pressure or the like. Also, in the case where the contents are reproduced on a special occasion such as a commencement or a wedding ceremony, the surrounding environment at the time of content reproduction may be stored by the user in association with the particular contents.

Japanese Patent Application Laid-Open (JP-A) No. 2002-344904 discloses a content reproducing apparatus for reproducing contents and generating an assessment value by measuring the reaction of a viewer/listener of the contents reproduced. In the contents reproducing apparatus described in JP-A-2002-344904, for example, the brightness of an image and the acoustic level of a predetermined scene and subsequent scenes are changed in accordance with the assessment value generated.

### SUMMARY OF THE INVENTION

In the related art, metadata recorded in association with contents is information added by content producers including performers, casts and the summary. The operating information input from the operation input unit or the change of the emotion of the user or the environment surrounding the user at the time of reproduction of the contents described above have not been recorded as metadata. Also, in the content reproducing apparatus described in JP-A-2002-344904, the reproduction characteristics of the contents being reproduced are changed in accordance with the assessment value generated, and contains no description of recording the operating information from the operation input unit as metadata.

For example, in the case where the operating information from the operation input unit reflecting the liking of the user about the contents can be recorded as metadata, the contents reflecting the liking of the user indicated by the metadata thus recorded may be reproduced.

Also, in the case where the psychological state or the surrounding environment of the user at the time of past reproduction of the contents can be recorded as metadata in association with the contents, on the other hand, the psychological state or the surrounding environment of the user at the time of past reproduction of the contents may be reconstructed by reproducing the same contents in accordance with the metadata.

Accordingly, it is desirable to provide a recording apparatus and a recording method for generating operation metadata using operating information from an operation input unit and recording the operation metadata thus generated in a recording medium.

It is also desirable to provide a reproducing apparatus, a reproducing method, a recording and reproducing apparatus and a recording and reproducing method for reproducing contents in accordance with operation metadata recorded.

It is still desirable to provide a recording medium having recorded therein operation metadata generated using operating information from an operation input unit.

According to an embodiment of the present invention, there is provided a recording apparatus including:

a content provider for providing contents;

an operation input unit for controlling the operation of the content provider;

an operation metadata generating unit for generating operation metadata using operating information from the operation input unit; and

a recording processing unit for recording the generated operation metadata in a recording medium in association with the contents.

According to another embodiment of the present invention, there is provided a reproducing apparatus for reproducing contents provided by a content provider, including:

a reproduction processing unit for reproducing, from a recording medium, operation metadata generated using operating information from an operation input unit for controlling the content provider; and

a reproduction control unit for reproducing the contents in a reproduction mode corresponding to the operation metadata.

According to still another embodiment of the present invention, there is provided a recording and reproducing apparatus including:

a content provider for providing contents;

an operation input unit for controlling the operation of the content provider;

an operation metadata generating unit for generating operation metadata using operating information from the operation input unit;

a recording processing unit for recording the generated operation metadata in a recording medium in association with the contents;

a reproduction processing unit for reproducing the operation metadata from the recording medium; and

a reproduction control unit for reproducing the contents in a reproduction mode corresponding to the operation metadata.

According to still another embodiment of the present invention, there is provided a recording method including the steps of:

providing contents from a content provider;

generating operation metadata using operating information from an operation input unit for controlling the operation of the content provider; and

recording the operation metadata in a recording medium in association with the contents.

According to still another embodiment of the present invention, there is provided a reproducing method for reproducing contents provided by a content provider, including the steps of:

reproducing, from a recording medium, operation metadata generated using operating information from an operation input unit for controlling the operation of the content provider; and

reproducing the contents in a reproduction mode corresponding to the operation metadata.

According to still another embodiment of the present invention, there is provided a recording and reproducing method including the steps of:

providing contents from a content provider;

generating operation metadata using operating information from an operation input unit for controlling the operation of the content provider;

recording the operation metadata in a recording medium in association with the contents;

reproducing the recording medium having the operation metadata recorded therein; and

reproducing the contents in a reproduction mode corresponding to the operation metadata.

According to still another embodiment of the present invention, there is provided a recording medium having recorded therein, in association with contents, operation metadata generated using operating information from an operation input unit for controlling the operation of a content provider for providing the contents.

According to the embodiments of the invention, operation metadata may be generated using operating information from an operation input unit, and the operation metadata thus generated may be recorded in a recording medium. By reproducing contents in accordance with the operation metadata thus recorded, the contents reflecting the liking of a user may be reproduced.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the configuration of a recording and reproducing apparatus according to a first embodiment of the invention;

FIG. 2 is a schematic diagram showing the configuration of a remote control unit according to the first embodiment of the invention;

FIG. 3 is a flowchart showing a flow of a process of recording operation metadata according to the first embodiment of the invention;

FIG. 4 is a flowchart showing a flow of a process of reproducing contents using the operation metadata according to the first embodiment of the invention;

FIG. 5 is a block diagram showing the configuration of a recording and reproducing apparatus according to a second embodiment of the invention;

FIG. 6 is a schematic diagram showing an example of the heart rate detected by a human body sensor of the recording and reproducing apparatus according to the second embodiment;

FIG. 7 is a schematic diagram showing an example of the correspondence between the time counted and the content reproduction point in the recording and reproducing apparatus according to the second embodiment;

FIG. 8 is a schematic diagram showing the content reproduction points and the corresponding heart rates;

FIG. 9 is a flowchart showing a flow of a process of recording sensing metadata according to the second embodiment of the invention; and

FIG. 10 is a flowchart showing a flow of a process of reproducing contents in accordance with the sensing metadata according to the second embodiment of the invention.

### DESCRIPTION OF THE PREFERRED EMBODIMENTS

Embodiments of the invention will be explained below with reference to the drawings. In this specification, the term “contents” is defined as at least one of video information and audio information, and each “content” is specified by an identifier (hereinafter referred to as content ID (identifier) appropriately). The video information includes all the visually recognizable information such as an image, a still picture such as a photo, graphics, an electronic book and text information displayed with them, while the audio information includes all the aurally recognizable information such as a music, a natural sound and a speaking voice. Also, viewers viewing video contents and listeners listening to audio contents are collectively referred to as user.

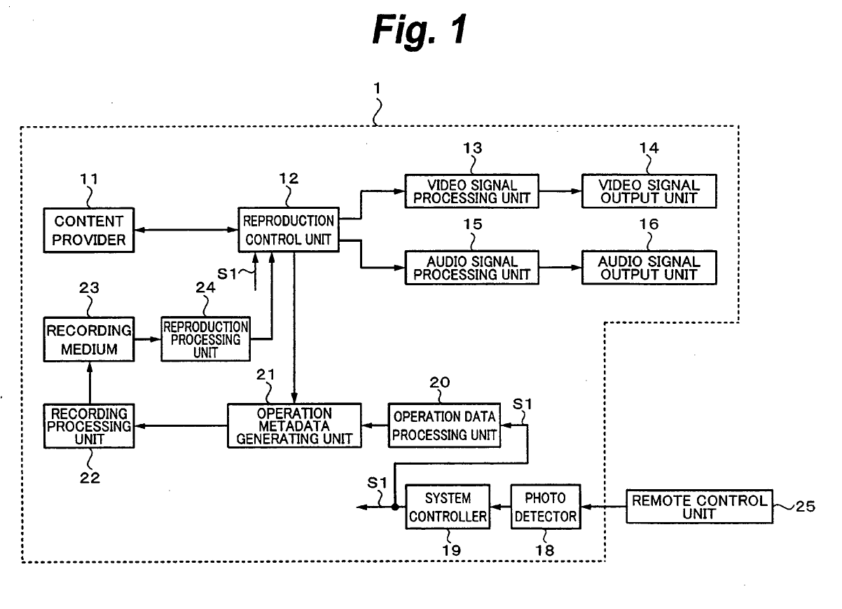

In FIG. 1, reference numeral 1 designates a main configuration of a recording and reproducing apparatus according to a first embodiment of the invention. The recording and reproducing apparatus 1 is configured to include a content provider 11, a reproduction control unit 12, a video signal processing unit 13, a video signal output unit 14, an audio signal processing unit 15, an audio signal output unit 16, a photo detector 18, a system controller 19, an operation data processing unit 20, an operation metadata generating unit 21, a recording processing unit 22, a recording medium 23 and a reproduction processing unit 24.

Reference numeral 25 designates an example of an operation input unit such as a remote control unit for remotely controlling the operation of the recording and reproducing apparatus 1 using infrared light. An operation signal generated by the user operation of the remote control unit 25 is received by the photo detector 18 in which the signal is converted into an electrical signal. The signal thus converted is supplied from the photo detector 18 to the system controller 19, from which a control signal corresponding to the operation signal is sent out to each unit of the recording and reproducing apparatus 1. Incidentally, the control signals transmitted to the various units of the recording and reproducing apparatus 1 from the system controller 19 are collectively called a control signal S1.

A user ID for identifying a user of contents may be input by way of the remote control unit 25, and the user ID thus input may be transmitted to the recording and reproducing apparatus 1. According to this embodiment of the invention, the remote control unit 25 is employed as an example of the operation input unit. Nevertheless, a button, a dial, etc. mounted on the housing of the recording and reproducing apparatus 1 may alternatively be used.

Each component part of the recording and reproducing apparatus 1 will be explained. The content provider 11 is, for example, a recording or storage medium including an optical disk such as compact disk read-only memory (CD-ROM) or digital versatile disk read-only memory (DVD-ROM), a semiconductor memory or a magnetic tape. The content provider 11 is not limited to the recording or storage medium removably mounted on the recording and reproducing apparatus 1, but may be a hard disk drive (HDD) built in the recording and reproducing apparatus 1. Also, the content provider 11 includes a content distribution server, etc. for distributing contents through TV broadcasting such as terrestrial analog/digital broadcasting or broadcasting satellite (BS) digital broadcasting or the internet.

Also, the content provider 11 supplies the contents corresponding to the content ID designated by the input operation of the user to the reproduction control unit 12, as described below.

The reproduction control unit 12 executes a process of reproducing contents supplied from the content provider 11 in a normal reproduction mode. The reproduction process executed by the reproduction control unit 12 is varied depending on the means providing the contents. For example, in the case where the contents are recorded in an optical disk, an optical pickup of the reproduction control unit 12 reads a signal and subjects the signal thus read to a demodulation process and an error correcting process. The signal thus processed is provisionally written in a buffer memory. The signal written in the buffer memory is demultiplexed thereby to separate the multiplexed video and audio signals from each other. The video signal thus separated is supplied to the video signal processing unit 13, and the audio signal is supplied to the audio signal processing unit 15.

In the case where a text signal is recorded in the optical disk, on the other hand, the text signal separated by the demultiplexing process is supplied to a text signal processing unit (not shown). The text signal decoded in the text signal processing unit is superposed on the video signal as required, and presented to the user.

In the case where the contents are provided by the BS digital broadcasting, on the other hand, the reproduction control unit 12 executes a process of selecting a target carrier from a received radio wave, a demodulation process, an error correcting process, a descramble process, a demultiplexing process and a packet selecting process, etc. thereby to extract intended video packetized elementary stream (PES) and audio PES. The video PES thus selected is supplied to the video signal processing unit 13, while the audio PES is supplied to the audio signal processing unit 15. In this way, the reproduction control unit 12 executes the appropriate process in accordance with the content provider 11. It may be also possible to switch the processes executed in the reproduction control unit 12.

The reproduction control unit 12 is supplied with operation metadata from the reproduction processing unit 24. The reproduction control unit 12, in addition to the normal reproduction process, executes a process of reproducing the contents supplied from the content provider 11 in a reproduction mode corresponding to the operation metadata supplied from the reproduction control unit 24. The operation metadata is described later.

Also, the reproduction control unit 12 is supplied with the control signal S1 from the system controller 19. In accordance with the control signal S1, the reproduction control unit 12 controls the content provider 11, and executes such processes as reproduction, rewinding, rapid feed, pause, etc. for the contents supplied from the content provider 11. Also, the reproduction control unit 12 controls the content provider 11 in such a manner as to acquire the contents selected by the user in accordance with the control signal S1 and display a predetermined scene.

The video signal processing unit 13 executes a process of decoding a video signal supplied thereto. The video signal supplied to the video signal processing unit 13 is compression coded by, for example, the MPEG (Moving Picture Coding Experts Group) 2 scheme. Thus, the video signal processing unit 13 executes a process of decoding the compression-coded video signal. Further, the video signal processing unit 13 executes a digital-to-analog (D/A) conversion process of converting the decoded digital video signal into an analog video signal as required. The video signal converted into the analog signal is supplied to the video signal output unit 14.

The video signal output unit 14 is a monitor such as a cathode ray tube (CRT), a liquid crystal display (LCD) or organic electroluminescence (EL). The video signal supplied from the video signal processing unit 13 is reproduced from the video signal output unit 14.

The audio signal processing unit 15 executes a process of decoding an audio signal supplied thereto. The audio signal supplied to the audio signal processing unit 15 is compression coded by such a scheme as MP3 (MPEG1-Audio Layer-III) or MPEG2AAC (advanced audio coding). The audio signal processing unit 15 thus executes a process of decoding the audio signal compression coded. The audio signal processing unit 15 further executes a digital-to-analog (D/A) conversion process of converting the decoded digital audio signal into an analog signal as required. The audio signal thus converted to the analog signal is supplied to the audio signal output unit 16.

The audio signal output unit 16 is a speaker, a headphone, etc. The audio signal supplied from the audio signal output unit 15 is reproduced from the audio signal output unit 16.

In the video signal processing unit 13 and the audio signal processing unit 15, the video signal and the audio signal are decoded based on timing information such as decoding time stamp (DTS) recorded in the optical disk together with the contents or superposed as PES on the broadcast wave. Also, the video signal and the audio signal are presented to the user by the timing information such as presentation time stamp (PTS) recorded in the optical disk together with the contents or multiplexed as PES on the broadcast wave. Thus, the video signal and the audio signal may be synchronized with each other.

At least one of the video signal output unit 14 and the audio signal output unit 16 may be formed as a member independent of the recording and reproducing apparatus 1. For example, the video signal may be transmitted by radio to the video signal output unit 14 located at a distance from the recording and reproducing apparatus 1, and the video signal may be reproduced from the video signal output unit 14.

The photo detector 18 receives an operation signal on the operating information generated by the user operation of the remote control unit 25. The operation signal received by the photo detector 18 is converted into an electrical signal. The signal thus converted is supplied to the system controller 19. The system controller 19 generates a control signal S1 corresponding to the operation signal, and the control signal S1 thus generated is transmitted to each unit of the recording and reproducing apparatus 1 and to the operation data processing unit 20 at the same time. The operation data processing unit 20 executes the appropriate process such as the amplification of the control signal S1, and the control signal S1 thus processed is supplied to the operation metadata generating unit 21.

The operation metadata generating unit 21 generates operation metadata using the operating information from the remote control unit 25. Operating information such as “the operation is performed to skip a certain content” or “the operation of repeating the reproduction of a certain part of the contents subjected to the rewinding process is performed” is used to identify the information on the liking of the user about the contents, and the information thus identified is generated by the operation metadata generating unit 21 as operation metadata. The operation metadata is described in, for example, the XML (extensible Markup Language) format.

Also, the operation metadata generating unit 21 is supplied with the content ID for identifying the contents reproduced in a normal mode from the reproduction control unit 12. The operation metadata generating unit 21 supplies the operation metadata, the content ID and the user ID to the recording processing unit 22.

The recording processing unit 22 converts the operation metadata, the user ID and the content ID thus supplied thereto into a format adapted for the recording medium 23, and executes the process of recording the converted operation metadata, etc. in the recording medium 23 in association with the contents. The recording processing unit 22 executes the recording process corresponding to the recording medium 23. The recording medium 23 includes a write-once or rewritable optical disk such as a CD-R (recordable), a CD-RW (rewritable), a DVD-R or a DVD-RW, or a magnetic tape. Also, such a storage medium as a semiconductor memory or an HDD built in the recording and reproducing apparatus 1 serves the purpose.

The reproduction processing unit 24 executes a process of reproducing the operation metadata recorded in the recording medium 23. The reproduction processing unit 24 executes, for example, a process of reproducing, from the recording medium 23, operation metadata specified by the user ID and the content ID input by the user. The reproduction processing unit 24 executes an appropriate reproduction process corresponding to the recording medium 23. The operation metadata is reproduced from the recording medium 23 by the reproduction process executed by the reproduction processing unit 24, and the operation metadata thus reproduced is supplied to the reproduction control unit 12.

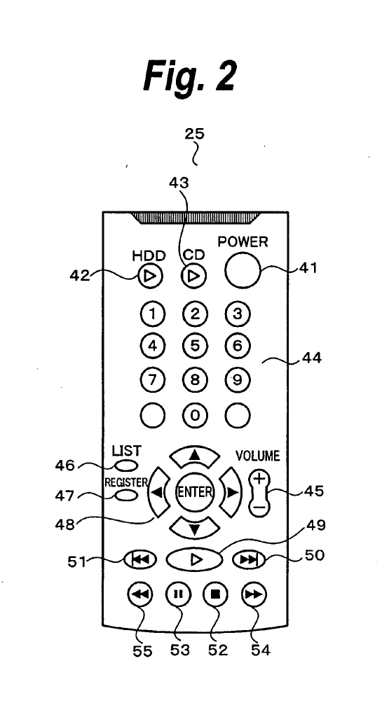

Next, the remote control unit 25 according to the embodiment of this invention will be explained. FIG. 2 shows the configuration of the remote control unit 25 according to the embodiment of the invention. The remote control unit 25 includes a POWER button 41 to turn on/off the power supply. Also, buttons such as an HDD button 42 and a CD button 43 for switching the contents supplied from the content provider 11 are arranged. Buttons for receiving the broadcast wave and viewing the DVD may of course be arranged. The buttons designated by reference numeral 44 are for inputting numerals or selecting a broadcast channel. The user ID can also be input by way of the buttons 44.

Reference numeral 45 designates a button for changing the sound volume of contents reproduced. A LIST button 46 is for displaying a plurality of play lists classified according to the features shared by a plurality of music contents. Also, the REGISTER button 47 is for registering the contents in a given play list.

Reference numeral 48 designates direction keys for designating left, right, up and down and an ENTER button. For example, a plurality of music contents recorded in a CD are displayed, and the cursor is moved using the direction keys thereby to select desired contents. Then, by using the ENTER button, the music contents are selected.

Further, the remote control unit 25 includes a PLAY button 49 for reproducing the contents, a button 50 for reproducing the next contents, a button 51 for reproducing the preceding contents, a STOP button 52 for stopping the reproduction and various operations, a PAUSE button 53, a RAPID FEED button 54 for rapidly feeding the contents in reproduction, and a REWIND button 55 for rewinding the contents in reproduction.

The remote control unit 25 shown in FIG. 2 is only an example, and may be replaced with a device having operating means in the form of a dial, a lever or a stick. Also, a predetermined instruction may be given to the recording and reproducing apparatus 1 by the user shaking the remote control unit.

Next, a specific example of recording the operation metadata will be explained. An explanation is given, for example, about a case in which the content provider 11 is a CD with a plurality of music contents recorded therein and operation metadata is generated using operating information for a single one of the plurality of music contents. Assume that the operation metadata is data indicating the liking of the users for each music content, and the degree of the liking is digitized with 0 as a base. Also, assume that the user ID of the user of the music contents is transmitted to the recording and reproducing apparatus 1 from the remote control unit 25.

First, the user depresses the CD button 43 of the remote control unit 25, followed by depressing the PLAY button 49. Then, the music contents (hereinafter referred to as the music contents A) from the content provider 11 are supplied to the reproduction control unit 12. The reproduction control unit 12 executes the reproduction process in the normal mode thereby to reproduce the music contents A. In the process, the reproduction control unit 12 supplies the content ID specifying the music contents A to the operation metadata generating unit 21.

Assume that during the reproduction of the music contents A, the user depresses the button 50 of the remote control unit 25. The operating information from the remote control unit 25 is supplied to the system controller 19 through the photo detector 18. In the system controller 19, a control signal S1 associated with the operating information indicating the depression of the button 50 is generated, and the control signal S1 thus generated is supplied to the reproduction control unit 12. Then, the reproduction control unit 12 controls the content provider 11 to acquire the next music contents (hereinafter referred to as the music contents B) following the music contents A, and reproduces the music contents B.

The control signal S1 generated by the system controller 19 is supplied to the operation metadata generating unit 21 through the operation data processing unit 20. The operation metadata generating unit 21, based on the fact that the button 50 is depressed and the music contents A in reproduction are switched to the music contents B, determines that the user is not very fond of the music contents A, and generates operation metadata one degree lower in the user liking of the music contents A. The operation metadata thus generated is supplied, together with the content ID and the user ID, to the recording processing unit 22 from the operation metadata generating unit 21.

The recording processing unit 22 converts the operation metadata, the content ID and the user ID supplied thereto into a format adapted for the recording medium 23, and executes a process of recording the converted operation metadata, content ID and user ID in the recording medium 23. In this way, operation metadata indicating the degree of liking of the music contents A is generated using the operating information from the remote control unit 25, and the operation metadata thus generated is recorded in the recording medium 23.

Assume, on the contrary, that the button 51 of the remote control unit 25 is depressed by the user during the reproduction of the music contents A. This indicates the desire of the user to listen to the music contents A again, and therefore, the operation metadata generating unit 21 generates operation metadata one degree higher in the liking of the music contents A.

Next, another example of the operation metadata will be explained. The exemplary operation metadata is generated for a part of a single music content and indicates a reproduction section of music contents to the user's liking.

Assume that during the reproduction of the music contents A, the user depresses the REWIND button 55 and then the STOP button 52, for example, of the remote control unit 25 and the music contents are reproduced from the rewound point. The operating information from the remote control unit 25 is supplied to the system controller 19 through the photo detector 18. The system controller 19 generates a control signal S1 associated with the operating information indicating that the REWIND button 51 and the STOP button 52 have been depressed, and the control signal S1 is supplied to the reproduction control unit 12. The reproduction control unit 12, by controlling the content provider 11, sets the reproduction start point of the music contents A to the point of depression of the STOP button 52 from the point of depression of the REWIND button 55. Thus, the music contents A are reproduced by the reproduction control unit 12 from the reproduction point thus set.

The control signal S1 is also supplied to the operation metadata generating unit 21 through the operation data processing unit 20. The operation metadata generating unit 21 generates the operation metadata using the operating information, for example, in the manner described below.

The operation metadata generating unit 21 acquires information on the reproduction point of the music contents A as of the depression of the REWIND button 55. The reproduction point information is supplied, for example, from the reproduction control unit 12. The reproduction point information thus acquired is registered as a starting point at which the REWIND button 55 is depressed. Next, the operation metadata generating unit 21 acquires the reproduction point information of the music contents A as of the depression of the STOP button 52. Then, the reproduction point information thus acquired is registered as an ending point at which the STOP button 52 is depressed. The reproduction section of the music contents A defined by the starting point and the ending point is regarded as an especially favorite section of the music contents A for the user.

The operation metadata generating unit 21 generates operation metadata on the reproduction point information corresponding to the starting and ending points and the information indicating that the user is fond of the particular section. The operation metadata is supplied to the recording processing unit 22 together with the content ID and the user ID. In the recording processing unit 22, the operation metadata, the content ID and the user ID are recorded in the recording medium 23.

Next, an example of operation metadata generated by use of operating information on a plurality of music contents will be explained. Assume, for example, that the HDD button of the remote control unit 25 is depressed and further the LIST button 46 is depressed, so that a plurality of play lists stored in the HDD providing an example of the content provider 11 are displayed on the video signal output unit 14. The user selects and determines a specified play list using the direction keys and the ENTER button 48 from the plurality of play lists on display. The series of operation of the remote control unit 25 by the user is supplied to the system controller 19 through the photo detector 18. A control signal S1 is generated in the system controller 19, and the control signal S1 thus generated is supplied to the reproduction control unit 12. The reproduction control unit 12 reproduces, in the normal mode, the plurality of music contents corresponding to the play list selected in accordance with the control signal S1. In the process, the content ID of the plurality of music contents corresponding to the selected play list is supplied from the reproduction control unit 12 to the operation metadata generating unit 21.

Also, the control signal S1 is supplied to the operation metadata generating unit 21 through the operation data processing unit 20. The operation metadata generating unit 21, determining that the music contents corresponding to the selected play list are the favorite music contents of the user, generates the operation metadata by upgrading the degree of liking of all the plurality of music contents corresponding to the play list by +1. The operation metadata thus generated are supplied to the recording processing unit 22 together with the content ID and the user ID specifying the plurality of music contents. The operation metadata, the content ID and the user ID thus supplied are recorded in the recording medium 23 by the recording processing unit 22. In this way, like the operation to select and reproduce the play list, operation metadata is generated using the operating information on the plurality of contents, and the operation metadata thus generated can be recorded in the recording medium 23.

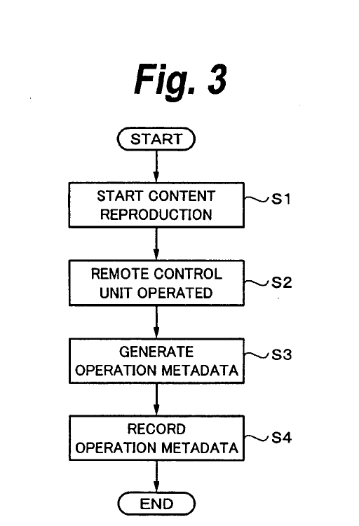

FIG. 3 is a flowchart showing a flow of a process of recording operation metadata according to the embodiment of the invention.

In step S1, a process of reproducing contents is executed. In the case where the remote control unit 25 is used, an operating signal is supplied to the system controller 19 through the photo detector 18. In the system controller 19, a control signal S1 corresponding to the operating signal is generated, and the control signal S1 thus generated is supplied to the reproduction control unit 12. The reproduction control unit 12 controls the content provider 11 in such a manner as to acquire predetermined contents from the content provider 11 in accordance with the control signal S1. The contents supplied from the content provider 11 are reproduced in the normal mode by the reproduction control unit 12. Next, the process proceeds to step S2.

In step S2, the user operates the remote control unit 25. Operating information from the remote control unit 25 is supplied to the system controller 19 through the photo detector 18. In the system controller 19, a control signal S1 corresponding to the operating information is generated. The control signal S1 thus generated is supplied to the operation metadata generating unit 21 through the operation data processing unit 20. Next, the process proceeds to step S3.

In step S3, a process of generating the operation metadata is executed. Specifically, the operation metadata generating unit 21 generates operation metadata using the control signal S1 providing the operating information from the remote control unit 25. The operation metadata thus generated is supplied to the recording processing unit 22 together with the content ID and the user ID. Next, the process proceeds to step S4.

In step S4, a recording process of recording the operation metadata is executed. The recording processing unit 22 converts the operation metadata, the content ID and the user ID supplied from the operation metadata generating unit 21 into a format suitable for the recording medium 23. Then, the recording processing unit 22 records in the recording medium 23 the operation metadata, the content ID and the user ID thus converted.

In the aforementioned processing flow, the operation metadata is generated from the information on the operation of the remote control unit performed at the time of reproducing the contents. As an alternative, however, the operation metadata may be generated using the operating information, etc. from the remote control unit 25 at the time of selecting the contents by not necessarily generating the contents.

Next, an example of the process of reproducing the contents in accordance with the operation metadata will be explained. The reproduction control unit 12 of the recording and reproducing apparatus 1 can reproduce the contents in accordance with the operation metadata other than by the normal reproduction mode.

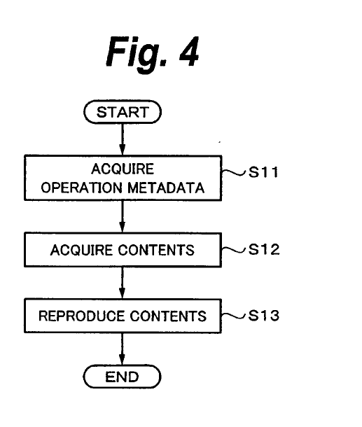

FIG. 4 is a flowchart showing a flow of a process of reproducing the contents in accordance with the operation metadata. In step S11, a process of acquiring operation metadata is executed. For example, the remote control unit 25 is used by the user, so that a process of reproducing the contents in accordance with the operation metadata is selected, and the content ID and the user ID are input. Operating information in the remote control unit 25 is supplied to the system controller 19 through the photo detector 18, and a control signal S1 is sent out to the reproduction control unit 12 and the reproduction processing unit 24 from the system controller 19.

The reproduction processing unit 24 reproduces the operation metadata recorded in the recording medium 23 in accordance with the control signal S1 sent out from the system controller 19. As the result of inputting the content ID and the user ID using the remote control unit 25, operation metadata to be reproduced can be specified. The reproduction process corresponding to the recording medium 23 is executed by the reproduction processing unit 24, and the operation metadata reproduced is supplied to the reproduction control unit 12. Next, the process proceeds to step S12.

In step S12, a process of acquiring the contents is executed. The reproduction control unit 12 acquires the contents corresponding to the content ID by controlling the content provider 11 in accordance with the control signal S1 supplied thereto. For example, in the case where the content provider 11 is an optical disk, the reproduction control unit 12 executes a process of acquiring the contents corresponding to the content ID by moving the optical pickup. In the case where the contents specified by the content ID cannot be supplied from the content provider 11, an error message is displayed on the video signal output unit 14, for example, or an alarm sound is issued from the audio signal output unit 16. Next, the process proceeds to step S13.

In step S13, a process of reproducing the contents is executed. In the reproduction process of step S13, the reproduction control unit 12 reproduces the contents in the reproduction mode corresponding to the operation metadata. For example, in the case where the content provider 11 is a CD and a plurality of music contents are recorded, the music contents are reproduced in the descending order of the degree of liking indicated by the operation metadata. Also, the sound volume and the frequency characteristic for the reproduction section of the repetitively reproduced music contents indicated by the operation metadata may be changed, and the music contents for the particular section may be emphasized in reproduction. Also, even in the case where the video contents are involved, a repetitively reproduced scene may be reproduced as a digest, or the repetitively reproduced scene may be emphasized by changing the brightness, color saturation and the color shade of the particular scene. In this way, the contents can be reproduced by reflecting the liking of the user by reproducing the contents in the reproduction mode corresponding to the operation metadata.

The process explained with reference to FIGS. 3 and 4 may be configured as a recording and reproducing method for recording operation metadata and reproducing contents in a reproduction mode corresponding to the operation metadata recorded.

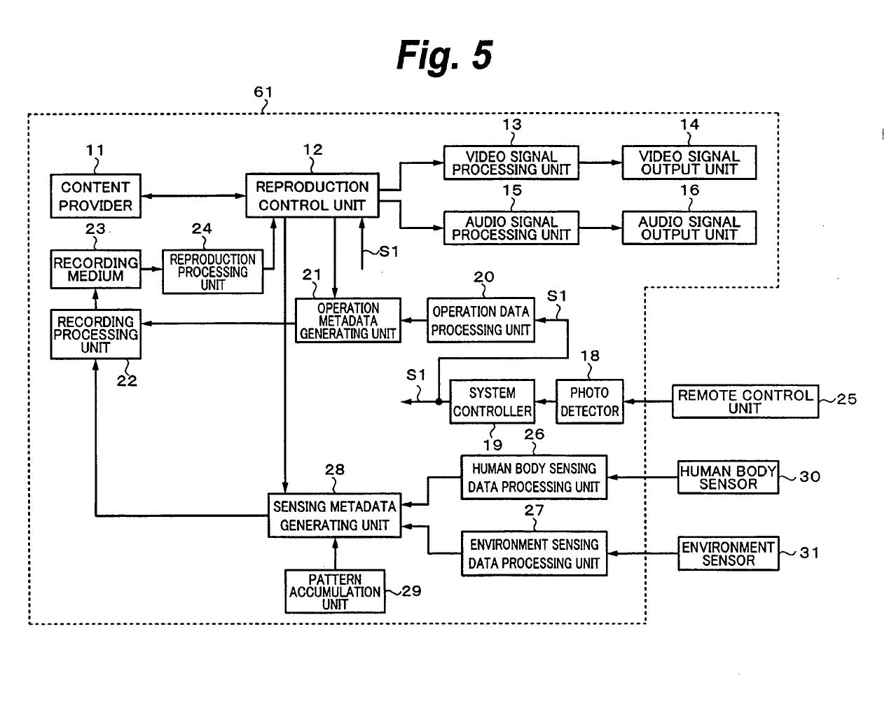

Next, a second embodiment of the invention will be explained. In FIG. 5, reference numeral 61 designates the essential configuration of a recording and reproducing apparatus according to the second embodiment. In the recording and reproducing apparatus 61, the component parts configured similarly to those of the recording and reproducing apparatus 1 according to the first embodiment are designated by the same reference numerals, respectively, and repetitive explanation thereof is omitted.

The recording and reproducing apparatus 61, like the recording and reproducing apparatus 1, is configured to include a content provider 11, a reproduction control unit 12, a video signal processing unit 13, a video signal output unit 14, an audio signal processing unit 15, an audio signal output unit 16, a photo detector 18, a system controller 19, an operation data processing unit 20, an operation metadata generating unit 21, a recording processing unit 22, a recording medium 23 and a reproduction processing unit 24. Operation metadata can be generated using operating information from a remote control unit 25. The operation metadata thus generated can be recorded in the recording medium 23. Also, the operation metadata recorded in the recording medium 23 can be reproduced by the reproduction processing unit 24, and the contents can be reproduced by the reproduction control unit 12 in a reproduction mode corresponding to the operation metadata.

The recording and reproducing apparatus 61 is configured to further include a human body sensing data processing unit 26, an environment sensing data processing unit 27, a sensing metadata generating unit 28 and a pattern accumulation unit 29. The apparatus 61 also includes at least one of a biological sensor 30 constituting an example of a biological information measuring unit and an environment sensor 31 constituting an example of an environment measurement unit.

The human body sensing data processing unit 26 converts information detected by the human body sensor 30 (hereinafter referred to as human body sensing data as required) into an electrical signal and records the human body sensing data thus converted. The human body sensing data constitutes biological information including the cardiogram, the respiration rate, the respiration period, the electromyogram, the cerebral blood stream, the electroencephalogram, the perspiration rate, the skin temperature, the iris diameter, the eye opening degree, the limb temperature, the body surface temperature, the expression change and the nictation change. Each item of the human body sensing data is specified by a user ID of each user. The human body sensing data recorded by the human body sensing data processing unit 26 is supplied to the sensing metadata generating unit 28.

The environment sensing data processing unit 27 converts information detected by the environment sensor 31 (hereinafter referred to as environment sensing data as required) into an electrical signal, and records the environment sensing data thus converted. The environment sensing data includes at least one of the temperature, the humidity, the air capacity, the atmospheric pressure, the weather and the place. Each item of the environment sensing data is specified by a user ID of each user. The environment sensing data recorded by the environment sensing data processing unit 27 is supplied to the sensing metadata generating unit 28.

The sensing metadata generating unit 28 generates sensing metadata using at least one of the human body sensing data and the environment sensing data supplied thereto. The sensing metadata generating unit 28 generates, for example, sensing metadata indicating the emotion or the emotional change of the user at the time of reproducing the contents using the human body sensing data supplied thereto. Also, the sensing metadata generating unit 28 generates sensing metadata indicating the environment surrounding the user at the time of reproducing the contents using the environment sensing metadata supplied thereto.

Specifically, the sensing metadata generating unit 28 determines the emotion (joy, sadness, surprise, anger, etc.) of the user for the section having the contents by collating the heart rate change or the expression change such as the lip motion or nictation obtained from the human body sensing data with the data accumulated in the pattern accumulation unit 29. Thus, sensing metadata indicating the emotional change of the user described in the XML format, for example, is generated. The pattern accumulation unit 29 preferably includes a nonvolatile memory such as an HDD to accumulate the emotion pattern corresponding to the change in the human body sensing data. For example, the pattern accumulation unit 29 accumulates therein the heart rate change, perspiration rate change and the body surface temperature change, etc. of the content user and the corresponding pattern of the emotion such as excitation, tension and stability.

Also, the emotion of the user such as surprise and tension can be determined by collating the perspiration rate, heart rate increase and the iris diameter change obtained from the human body sensing data, for example, with the data accumulated in the pattern accumulation unit 29. The sensing metadata generating unit 28 generates sensing metadata indicating the user emotion thus determined.

Also, the sensing metadata generating unit 28 generates sensing metadata indicating the environment surrounding the user at the time of reproducing the contents using the environment sensing data. Examples of the sensing metadata thus generated include the temperature, humidity, air capacity, atmospheric pressure, weather (fine, cloudy, rain, snow, storm, etc.) described in the XML format. Further, the longitude and latitude, for example, of the place at which the user exists at the time of reproducing the contents are generated by the sensing metadata generating unit 28 as the sensing metadata.

The sensing metadata generating unit 28 is supplied with the content ID for specifying the contents reproduced in the normal mode by the reproduction control unit 12. The title of the contents, for example, is used as the content ID. The sensing metadata, the user ID and the content ID are supplied from the sensing metadata generating unit 28 to the recording processing unit 22.

The recording processing unit 22 converts the sensing metadata, the user ID and the content ID supplied thereto into a format adapted for the recording medium 23, and executes a process of recording the converted sensing metadata, etc. in the recording medium 23 in association with the contents. The recording processing unit 22 executes the recording process corresponding to the recording medium 23.

The reproduction processing unit 24 may reproduce, like the operation metadata, the sensing metadata recorded in the recording medium 23. For example, the reproduction processing unit 24 executes a process of reproducing the sensing metadata specified by the user ID and the content ID input by the user from the recording medium 23. The sensing metadata is reproduced from the recording medium 23 by the reproducing process in the reproduction processing unit 24, and the sensing metadata thus reproduced is supplied to the reproduction control unit 12.

Next, the human body sensor 30 and the environment sensor 31 will be explained. The human body sensor 30 is a device mounted on the body of the user of the contents and capable of measuring various human body sensing data. The device of course may have not only the function of measuring the human sensing data but also other functions such as clocking. The human body sensor 30 according to the second embodiment is capable of radio communication with the recording and reproducing apparatus 61 and may transmit the measurement of the human body sensing data to the recording and reproducing apparatus 61.

The human body sensor 30 is not limited to the device mounted on the body of the content user, but also includes an imaging device for picking up an image of the expression of the user or an infrared light thermograph for measuring the body surface temperature of the user, mounted on the recording and reproducing apparatus 61.

The environment sensor 31 constituting an example of the environment measuring unit includes a thermometer, a hygrometer, an air flow meter, a barometer or an imaging device for determining the weather, and may be mounted on the body of the user or on the recording and reproducing apparatus 61. Also, the environment sensor 31 includes a global positioning system (GPS) receiving terminal for detecting the environment sensing data indicating the place. The environment sensor 31, therefore, can specify the place at which the contents are reproduced by the user with GPS. The place of the content reproduction may alternatively be specified by the communication conducted for position registration between a mobile phone of the user and the base station.

Next, an explanation is given about a specific example of the operation in which the sensing metadata generated by the sensing metadata generating unit 28 is recorded in the recording medium 23. In the specific example described below, assume that video contents having temporally changing information are supplied from the content provider 11. Also, assume that the human body sensor 30 is a cardiac meter of wrist watch type having the functions of both the wrist watch and the cardiac meter at the same time. The human body sensor 30 measures the heart rate of the user as an example of the human body sensing metadata. The heart rate is defined as the number of beats per minute (BPM). The heart rate measured by the human body sensor 30 is transmitted to the recording and reproducing apparatus 61 by radio communication together with the user ID indicating the user of the human body sensor 30.

Also, the time counted by the recording and reproducing apparatus 61 and the time counted by the human body sensor 30 are assumed to coincide with each other. The time counted by the recording and reproducing apparatus 61 and the time counted by the human body sensor 30 can be rendered to coincide with each other, for example, by the receipt of the radio wave representing the standard time by the recording and reproducing apparatus 61 and the human body sensor 30. The time counted by the recording and reproducing apparatus 61 and the time counted by the human body sensor 30 can be rendered to coincide with each other also by acquiring the standard time distributed through the internet.

The video contents are supplied from the content provider 11 and processed in the normal mode by the reproduction control unit 12. The video signal processing unit 13 and the audio signal processing unit 15 execute the decoding process or the like, so that the video is reproduced by the video signal output unit 14 and the audio is reproduced by the audio signal output unit 16. With the reproduction of the contents, the heart rate is measured by the human body sensor 30.

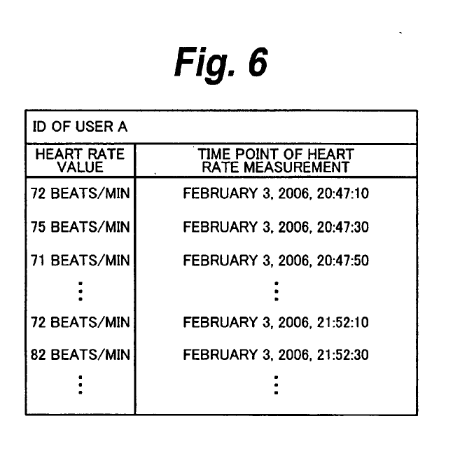

FIG. 6 shows an example of the heart rate of the user A measured by the human body sensor 30. In the human body sensor 30, the heart rate is sampled at a predetermined time point or a predetermined period. Also, information on the timing of the heart rate measurement is measured. In the case under consideration, as shown in FIG. 6, the heart rate 72 is measured on Feb. 3, 2006 at 20:47:10. The other heart rates are also measured in association with the timing information.

The user ID for identifying the user A, the heart rate of the user A measured at the time of normal-mode reproduction of the contents and the information on the timing at which each heart rate is measured (hereinafter referred to as the user ID, etc. appropriately) are transmitted from the human body sensor 30 to the recording and reproducing apparatus 61. The user ID may be a serial number added to the human body sensor 30 or the user ID may be input by the user A. The user ID, etc. are received by the recording and reproducing apparatus 61 and supplied to the human body sensing data processing unit 26. In the human body sensing data processing unit 26, the user ID, etc. transmitted from the human body sensor 30 are converted into an electrical signal, and the user ID, etc. thus converted are recorded. Then, the user ID, etc. thus recorded are supplied to the sensing metadata generating unit 28.

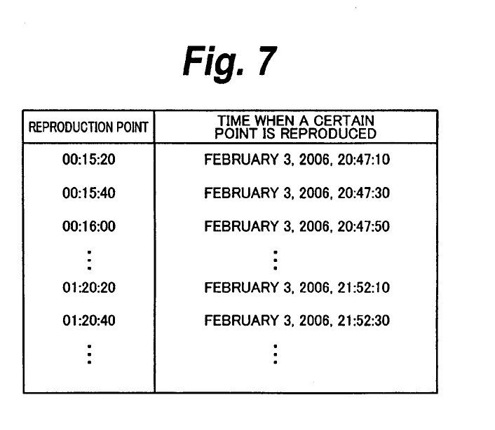

A clock circuit, etc. built in the recording and reproducing apparatus 61, on the other hand, may count the present time. Also, in the reproduction control unit 12, reproduction point information of the video contents reproduced in normal mode can be acquired. FIG. 7 shows an example of the reproduction point of the video contents corresponding to the timing information counted in the recording and reproducing apparatus 61. The reproduction point of the video contents is regarded as 00:15:20 for Feb. 3, 2006 at 20:47:10 counted in the recording and reproducing apparatus 1.

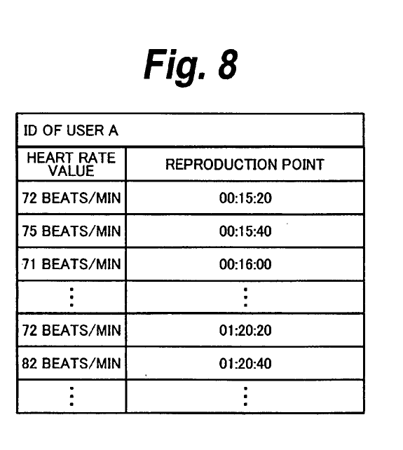

In the sensing metadata generating unit 28, the timing information at which the heart rate is measured and the reproduction point corresponding to the particular timing information are determined thereby to establish the correspondence between the reproduction point of the video contents and the heart rate measurement. As explained above with reference to FIGS. 6 and 7, for example, the human body sensor 30 measures the heart rate at 72 for Feb. 3, 2006 at 20:47:10, and the reproduction point of the video contents is 00:15:20. As shown in FIG. 8, therefore, the correspondence is established between the reproduction point of the video contents, i.e. 00:15:20 and the heart rate of 72. This is also the case with the other heart rates measured, with which the correspondence of the reproduction point of the video contents is established.

Next, the sensing metadata generating unit 28 extracts the emotion of the user corresponding to the heart rate change with reference to the past patterns accumulated in the pattern accumulating unit 29. For example, analogous ones of the past patterns accumulated in the pattern accumulating unit 29 are retrieved, and the emotion corresponding to the retrieved patterns is extracted as the emotion of the user at the time of content reproduction.

As an example, the heart rate slightly increases for the section of 00:15:40 from the reproduction point 00:15:20 of the video contents corresponding to the heart rate change from 72 to 75. The user, therefore, is considered to be excited at the time of reproduction of the video contents during this section. Also, in view of the fact that the heart rate slightly decreases for the section of 00:16:00 from the reproduction point 00:15:40 of the video contents corresponding to the heart rate change from 75 to 71, the user is considered to have become stable at the time of reproduction of the video contents for the particular section. Further, the user is considered to be surprised at the reproduction point 01:20:40 of the video contents when the heart rate is increased to 82.

Then, the sensing metadata generating unit 28 generates sensing metadata indicating the reproduction point and the reproduction section of the video contents and the corresponding user emotion. The sensing metadata generated in the sensing metadata generating unit 28 is supplied to the recording processing unit 22. Also, the user ID for specifying the user A of the contents reproduced in the normal mode and the content ID specifying the video contents reproduced in the normal mode are supplied from the sensing metadata generating unit 28 to the recording processing unit 22.

The recording processing unit 22 converts the sensing metadata, the user ID and the content ID supplied thereto into a format adapted for the recording medium 23. The sensing metadata, the user ID and the content ID converted into an appropriate format are recorded in the recording medium 23 by the recording process executed in the recording processing unit 22.

Incidentally, the specific example described above represents a case in which the sensing metadata is generated using the human body sensing data with the heart rate as an example. Nevertheless, the sensing data can also be generated also using the environment sensing data. The environment sensing data indicating the temperature, humidity, air capacity, weather, place, etc. are not necessarily measured chronologically.

Also, the contents such as a photo of which information remains unchanged on the time axis and the metadata generated from the environment sensing data may be recorded in the recording medium 23. In this case, the timing information is not necessarily required in the process of recording the sensing metadata.

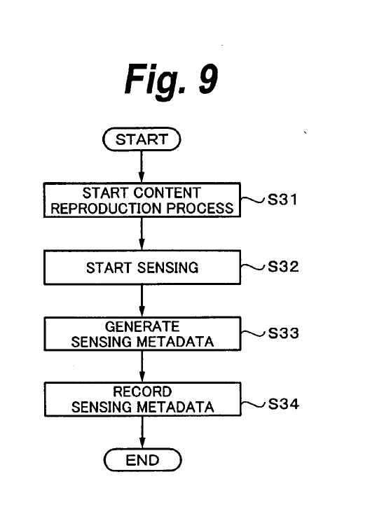

FIG. 9 is a flowchart showing a flow of a process of recording sensing metadata according to the second embodiment of the invention. In the process explained with reference to FIG. 9, the contents are regarded as music ones.

In step S31, a process of reproducing the contents is executed. Specifically, the music contents supplied from the content provider 11 are reproduced in the normal mode by the reproduction processing unit 12. The music contents thus reproduced are decoded by the audio signal processing unit 15, and the music contents are reproduced for the user from the audio signal output unit 16. After the content reproduction, the process proceeds to step S32.

In step S32, a sensing process is started. Specifically, at least one of the human body sensing data of the user at the time of content reproduction and the environment sensing data at the time of content reproduction is measured using at least one of the human body sensor 30 and the environment sensor 31, respectively. The human body sensing data thus measured is supplied to the human body sensing data processing unit 26. The environment sensing data measured, on the other hand, is supplied to the environment sensing data processing unit 27. At least one of the human body sensing data and the environment sensing data processed by the human body sensing data processing unit 26 and the environment sensing data processing unit 27, respectively, is supplied to the sensing metadata generating unit 28.

Incidentally, the timing at which the sensing processing operation is started in step S32, though preferably at the time of starting the content reproduction, may be during the content reproduction. With the start of the sensing operation, the process proceeds to step S33.

In step S33, a process of generating sensing metadata is executed in the sensing metadata generating unit 28. The sensing metadata generating unit 28 generates sensing metadata using at least one of the human body sensing metadata supplied from the human body sensing data processing unit 26 and the environment sensing metadata supplied from the environment sensing data processing unit 27. Upon generation of the sensing metadata, the process proceeds to step S34.

In step S34, a process of recording the sensing metadata thus generated is executed. The sensing metadata generated in step S33 is supplied to the recording processing unit 22. Also, the user ID for specifying the user of the music contents and the content ID for specifying the music contents are supplied to the recording processing unit 22. In the recording processing unit 22, the sensing metadata, the user ID and the content ID are converted into a format corresponding to the recording medium 23. The sensing metadata, the user ID and the content ID thus converted are recorded in the recording medium 23.

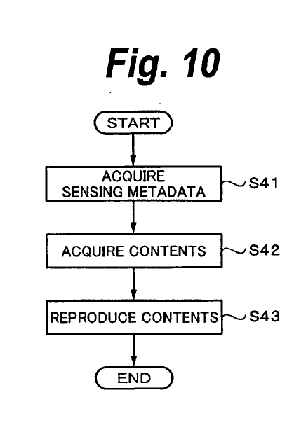

Next, a process of reproducing the sensing metadata recorded in the recording medium 23 is explained. FIG. 10 is a flowchart showing a flow of the reproduction process according to the second embodiment of the invention.

In step S41, a process of acquiring sensing metadata is executed. For example, a user ID and a content ID are input by the user, and a control signal S1 for the user ID and the content ID thus input is supplied to the reproduction processing unit 24 from the system controller 19. In accordance with the control signal S1 thus supplied, the reproduction processing unit 24 reproduces sensing metadata specified by the user ID and the content ID, from the recording medium 23. The sensing metadata thus reproduced is supplied to the reproduction control unit 12. Next, the process proceeds to step S42.

In step S42, a process of acquiring contents is executed. A control signal S1 for a content ID input by the user is supplied to the reproduction control unit 12. The reproduction control unit 12, by controlling the content provider 11 in accordance with the control signal S1 thus supplied thereto, acquires predetermined contents from the content provider 11. For example, a content distribution server is accessed, and the contents specified by the content ID are downloaded. The contents thus downloaded are supplied to the reproduction control unit 12. Also, in the case where the content provider 11 is an optical disk, the optical pickup is moved to a predetermined position so as to reproduce the contents specified by the content ID.

Incidentally, in the case where the contents specified by the content ID cannot be provided by the content provider 11, an error message is displayed, for example, on the video signal output unit 14 or an alarm sound is issued from the audio signal output unit 16. Next, the process proceeds to step S43.

In step S43, a process of reproducing the contents is executed. In step S43, the reproduction control unit 12 executes a reproduction process different from the reproduction in the normal mode, i.e. a process of reproducing the contents supplied from the content provider 11 in a reproduction mode corresponding to the sensing metadata supplied from the reproduction processing unit 24. An example of reproducing the contents in the reproduction mode corresponding to the sensing metadata will be explained below.

For example, in the case where video contents are involved, the reproduction control unit 12 changes the brightness level, the contrast and the color shade in accordance with the emotion of the user at the reproduction point or for the reproduction section described in the sensing metadata. In the case where the music contents are involved, on the other hand, the frequency characteristic or the volume level is changed or effects added by the reproduction control unit 12 in accordance with the emotion of the user for the section having the music contents described in the sensing metadata. Also, a scene corresponding to the reproduction point at which the user is determined as excited may be reproduced as a digest, or a scene with a modulated emotion of the user may be reproduced emphatically.

The video contents processed in the reproduction control unit 12 are supplied to the video signal processing unit 13, and the music contents are supplied to the audio signal processing unit 15. The video signal processing unit 13 and the audio signal processing unit 15 execute the decoding process or the like, so that the video contents are reproduced from the video signal output unit 14 and the music contents are reproduced from the audio signal output unit 16 in the reproduction mode corresponding to the sensing metadata.

In the case where sensing metadata are generated using the environment sensing metadata, on the other hand, the reproduction control unit 12 reproduces the contents in such a way that the user can recognize the surrounding environment indicated by the sensing metadata.

For example, in the case where video contents are involved, data indicating the atmospheric temperature, the humidity, the place, etc. obtained from the sensing metadata are superposed on the video contents by the reproduction control unit 12. The video contents thus superposed with the data are subjected to the decoding process, etc. in the video signal processing unit 13. The video contents subjected to the decoding process, etc. are reproduced by the video signal output unit 14. In the process, the video signal output unit 14 reproduces, together with the video contents, the text information indicating the atmospheric temperature, the humidity, the place, etc. at the time of past reproduction of the identical video contents. As a result, the user of the video contents can recognize the surrounding environment at the time of past reproduction of the video contents. Also, the surrounding environment such as the temperature and humidity at the time of past reproduction of the contents may be reconstructed by automatically adjusting an indoor air-conditioning equipment.

In the case where music contents are involved, on the other hand, the reproduction control unit 12 executes, for example, the process described below. In the case where the sensing metadata indicates the weather at the time of past reproduction of the music contents as the rain or the storm, the sound data of the rain or the wind, as the case may be, are superposed on the music contents by the reproduction control unit 12. The music contents superposed with the sound of the rain or the wind are supplied from the reproduction control unit 12 to the audio signal processing unit 15. The audio signal processing unit 15 for example, decodes the music contents, and the music contents thus processed are reproduced from the audio signal output unit 16. In the process, the user, by listening to the sound of the rain or the wind superposed on the music contents together with the music contents processed, can recognize the surrounding environment of the user at the time of past reproduction of the music contents. By recognizing the surrounding environment of the user at the time of past reproduction of the music contents, the memory of the user stored in association with the music contents may be recollected.

The sound data of the rain or the wind may alternatively be downloaded through the network by the reproduction control unit 12 controlling the content provider 11. The sound data of the rain or the wind thus downloaded are supplied from the content provider 11 to the reproduction control unit 12, in which the data of the rain or the wind, as the case may be, are superposed on the music contents.

Also, in the case where the sensing metadata indicating the place at which the user was located at the time of past audio content reproduction are recorded in the recording medium 23, the music contents may be reproduced in the manner described below. The music contents provided by the content provider 11 are subjected to the reproduction process by the reproduction control unit 12 and the decoding process, etc. by the audio signal processing unit 15, and reproduced from the audio signal output unit 16.

Also, sensing metadata indicating the place at which the user was located at the time of reproduction of the music contents is obtained by the reproduction process in the reproduction processing unit 24, and the sensing data thus obtained is supplied to the reproduction control unit 12. The reproduction control unit 12, by controlling the content provider 11, acquires the photo data on the landscape such as a mountain, a river, woods and a seashore at the user location indicated by the sensing metadata. By accessing the server for photo distribution, for example, the photo data of various landscapes can be acquired from the particular server. The photo data thus acquired is supplied from the content provider 11 to the reproduction control unit 12.

The photo data supplied to the reproduction control unit 12 is supplied to the video signal processing unit 13, in which the decoding process, etc. is executed. The photo data thus processed is supplied to the video signal output unit 14, from which the landscapes such as the mountain, the river, the woods and the seashore are reproduced. In this way, the music contents can be reproduced while rendering the user to visually recognize the surrounding landscape at the time of past reproduction of the music contents. The user of the music contents, by listening to the music contents while viewing the landscape reproduced by the video signal output unit 14, can recognize the surrounding landscape at the time of past reproduction of the music contents. As a result, the memory of the user stored in association with the music contents can be recollected.

As described above, by reproducing the contents in the reproduction mode corresponding to the sensing metadata, the user can recognize the emotional change of the user at the time of past content reproduction. Also, the surrounding environment of the user at the time of reproducing the past contents can be reconstructed. As a result, the memory stored with the contents can be recollected.

The process explained with reference to FIGS. 9 and 10 may be configured also as a recording and reproducing method for recording the sensing metadata and reproducing the contents in the reproduction mode corresponding to the sensing metadata recorded.

In the recording and reproducing apparatus 61, operation metadata and sensing metadata for one content can be recorded in the recording medium 23. For example, operation metadata is generated using operating information from the remote control unit 25 during the reproduction of given contents in the normal mode. Also, the sensing metadata is generated using at least one of human body sensing data and environment sensing data detected during the reproduction of the contents in the normal mode. The operation metadata and the sensing metadata thus generated are recorded in the recording medium 23 by the recording processing unit 22 together with the content ID for identifying the contents and the user ID.

Also, the operation metadata and the sensing metadata recorded in the recording medium 23 are reproduced by the reproduction processing unit 24, and supplied to the reproduction control unit 12. The reproduction control unit 12 can reproduce the contents in accordance with the operation metadata and the sensing metadata. For example, the order in which the contents are reproduced is changed in accordance with the operation metadata and the mode in which the contents are reproduced is changed in accordance with the sensing metadata.

Embodiments of the invention are specifically explained above. The invention, however, is not limited to the aforementioned embodiments. It should be understood by those skilled in the art that various modifications, combinations, sub-combinations and alterations may occur depending on design requirements and other factors insofar as they are within the scope of the appended claims or the equivalents thereof.

The first embodiment, though explained above as a recording and reproducing apparatus, can also be configured as a recording apparatus for recording operation metadata. Also, it can be configured as a reproducing apparatus for reproducing contents in a reproduction mode corresponding to operation metadata recorded in a recording medium.

The second embodiment, though explained above as a recording and reproducing apparatus, can also be configured as a recording apparatus for recording operation metadata and sensing metadata. Also, it can be configured as a reproducing apparatus for reproducing contents in a reproduction mode corresponding to operation metadata and sensing metadata recorded in a recording medium.

In the reproduction control unit 12, the process executed to reproduce the contents in the normal mode and the process executed to reproduce the contents in the reproduction mode corresponding to the operation metadata may be switched by the user.

Also, in the case where the content provider 11 is a write-once or rewritable optical disk or a semiconductor memory, the operation metadata and the sensing metadata generated may be recorded in the content provider 11.

Further, the operation metadata and the sensing metadata recorded in the recording medium 23 may be reproduced using an information processing system such as a personal computer. The users with which similar operation metadata and sensing metadata are added for the same contents may be retrieved and a community may be formed through the contents. Also, the propensities of the user may be acquired from the operation metadata and the sensing metadata and the other contents may be recommended.

Also, the recording and reproducing apparatus 1 and the recording and reproducing apparatus 61 described above are not limited to the stationary type, but may be portable apparatuses.

Further, each means constituting the apparatus according to the embodiment of the invention may be configured of a dedicated hardware circuit or implemented by software or a programmed computer. Also, the program describing the processing contents may be recorded in a computer readable recording medium such as a magnetic recording device, an optical disk, a magnetooptic disk or a semiconductor memory.

What is claimed is:

1. A recording apparatus comprising:
a content provider for providing contents;
an operation input unit for controlling the operation of the content provider;
an operation metadata generating unit for generating operation metadata using operating information from the operation input unit; and
a recording processing unit for recording the generated operation metadata in a recording medium in association with the contents.

2. The recording apparatus according to claim 1,
wherein the operation metadata generating unit generates the operation metadata using operating information for a single content.

3. The recording apparatus according to claim 1,
wherein the operation metadata generating unit generates the operation metadata using operating information for a plurality of contents.

4. The recording apparatus according to claim 1, further comprising:
at least one of a biological information measuring unit for measuring biological information of a user at the time of content reproduction and an environment measuring unit for measuring the surrounding environment of the user at the time of content reproduction; and
a sensing metadata generating unit for generating sensing metadata using information detected by at least one of the biological information measuring unit and the environment measuring unit.

5. A reproducing apparatus for reproducing contents provided by a content provider, comprising:
a reproduction processing unit for reproducing, from a recording medium, operation metadata generated using operating information from an operation input unit for controlling the content provider; and
a reproduction control unit for reproducing the contents in a reproduction mode corresponding to the operation metadata.

6. The reproducing apparatus according to claim 5,
wherein the operation metadata is generated using operating information for a single content.

7. The reproducing apparatus according to claim 5,
wherein the operation metadata is generated using operating information of a plurality of contents.

8. The reproducing apparatus according to claim 5,
wherein sensing metadata generated using information detected by at least one of a biological information measuring unit for measuring biological information of a user at the time of content reproduction and an environment measuring unit for measuring the surrounding environment of the user at the time of content reproduction is recorded in the recording medium.

9. A recording and reproducing apparatus comprising:
a content provider for providing contents;
an operation input unit for controlling the operation of the content provider;
an operation metadata generating unit for generating operation metadata using operating information from the operation input unit;
a recording processing unit for recording the generated operation metadata in a recording medium in association with the contents;
a reproduction processing unit for reproducing the operation metadata from the recording medium; and
a reproduction control unit for reproducing the contents in a reproduction mode corresponding to the operation metadata.

10. The recording and reproducing apparatus according to claim 9,
wherein the operation metadata generating unit generates the operation metadata using operating information for a single content.

11. The recording and reproducing apparatus according to claim 9,
wherein the operation metadata generating unit generates the operation metadata using operating information for a plurality of contents.

12. The recording and reproducing apparatus according to claim 9, further comprising:
at least one of a biological information measuring unit for measuring biological information of a user at the time of content reproduction and an environment measuring unit for measuring the surrounding environment of the user at the time of content reproduction; and
a sensing metadata generating unit for generating the sensing metadata using information detected by at least one of the biological information measuring unit and the environment measuring unit.

13. A recording method comprising the steps of:
providing contents from a content provider;
generating operation metadata using operating information from an operation input unit for controlling the operation of the content provider; and
recording the operation metadata in a recording medium in association with the contents.

14. The recording method according to claim 13,
wherein the operation metadata is generated in the operation metadata generating step using operating information for a single content.

15. The recording method according to claim 13,
wherein the operation metadata is generated in the operation metadata generating step using operating information for a plurality of contents.

16. The recording method according to claim 13, further comprising the step of:
generating sensing metadata using at least one of biological information of a user measured at the time of content reproduction and information on the surrounding environment of the user measured at the time of content reproduction.

17. A reproducing method for reproducing contents provided by a content provider, comprising the steps of:
reproducing, from a recording medium, operation metadata generated using operating information from an operation input unit for controlling the operation of the content provider; and
reproducing the contents in a reproduction mode corresponding to the operation metadata.

18. The reproducing method according to claim 17,
wherein the operation metadata is generated using operating information for a single content.

19. The reproducing method according to claim 17,
wherein the operation metadata is generated using operating information for a plurality of contents.

20. The reproducing method according to claim 17,
wherein sensing metadata generated using at least one of biological information of a user measured at the time of content reproduction and information on the surrounding environment of the user measured at the time of content reproduction is recorded in the recording medium.

21. A recording and reproducing method comprising the steps of:
providing contents from a content provider;
generating operation metadata using operating information from an operation input unit for controlling the operation of the content provider;
recording the operation metadata in a recording medium in association with the contents;
reproducing the recording medium having the operation metadata recorded therein; and
reproducing the contents in a reproduction mode corresponding to the operation metadata.

22. The recording and reproducing method according to claim 21,
wherein the operation metadata is generated using operating information for a single content.

23. The recording and reproducing method according to claim 21,
wherein the operation metadata is generated using operating information for a plurality of contents.

24. The recording and reproducing method according to claim 21, further comprising the step of:
generating sensing metadata using at least one of biological information of a user measured at the time of content reproduction and information on the surrounding environment of the user measured at the time of content reproduction.

25. A recording medium having recorded therein, in association with contents, operation metadata generated using operating information from an operation input unit for controlling the operation of a content provider for providing the contents.

26. The recording medium according to claim 25, further having recorded therein sensing metadata generated using at least one of biological information of a user measured at the time of content reproduction and information on the surrounding environment of the user measured at the time of content reproduction.
